(19) United States
(12) Patent Application Publication
(10) Pub. No.: US 2009/0165819 A1
(43) Pub. Date: Jul. 2, 2009

(54) METHOD FOR TREATING FINE STRUCTURE, SYSTEM FOR TREATING FINE STRUCTURE, AND METHOD FOR PRODUCING ELECTRONIC DEVICE

(75) Inventors: Naoya HAYAMIZU, Kanagawa-ken (JP); Hiroshi Fujita, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/342,619

(22) Filed: Dec. 23, 2008

(30) Foreign Application Priority Data
Dec. 28, 2007 (JP) 2007-339999

(51) Int. Cl. B08B 3/04

(52) U.S. Cl. 134/10; 134/30; 134/13; 134/109; 134/95.2; 134/33

(57) ABSTRACT

A method for treating a fine structure, includes supplying a liquid to a surface of the fine structure having protrusions on the surface thereof; and thereby treating the surface of the fine structure. The liquid has a smaller surface tension than that of water and is not substantially compatible with water.

### CROSS-REFERENCE TO RELATED APPLICATIONS

This application is based upon and claims the benefit of priority from the prior Japanese Patent Application No. 2007-339999, filed on Dec. 28, 2007; the entire contents of which are incorporated herein by reference.

### BACKGROUND OF THE INVENTION

1. Field of the Invention

This invention relates to a method for treating a fine structure, a system for treating a fine structure, and a method for producing an electronic device.

2. Background Art

In producing an electronic device such as semiconductor device or MEMS (Micro Electro Mechanical Systems), a fine structure having protrusions such as fine wall bodies on a surface thereof is often formed by using a lithography technique. And, rinse is performed so that organic contamination or inorganic contamination generated in the production process is removed to maintain the surface of the fine structure.

In such rinse, the attached organic matter or the like is removed by supplying rinse solution such as pure water to the surface of the fine structure. And, in order to reduce the residual water droplet or water mark, alcohol such as isopropyl alcohol is supplied to the surface to be rinsed in drying (see, for example, JP-A 2000-3897 (Kokai)).

Moreover, in the rinse of a wafer, there is proposed a technique in which by recycling the rinse water after the rinse, waste of the rinse water is prevented and environmental load is reduced (see, JP-A 2003-297795 (Kokai)).

However, in such a technique as disclosed in JP-A 2000-3897 (Kokai), the effect of surface tension of the residual liquid (rinse solution) between the fine protrusions formed on the surface of the fine structure is not considered, and there has been a danger that the fine protrusions are deformed or destroyed by the surface tension.

Moreover, in the technique disclosed in JP-A 2003-297795 (Kokai), isopropyl alcohol and ultrapure water are separated by utilizing the difference of the boiling points, and the impurities composed of the residual component are separated and removed. However, separation and removal of metal impurities (metal ions) being dissolved in the rinse solution after the rinse is not considered, and there is a danger that the ionic contamination is generated by recycling the rinse solution in which the metal impurities (metal ions) are dissolved.

### SUMMARY OF THE INVENTION

According to an aspect of the invention, there is provided a method for treating a fine structure, including: supplying a liquid that has a smaller surface tension than that of water and is not substantially compatible with water, to a surface of the fine structure having protrusions on the surface thereof; and thereby treating the surface of the fine structure.

According to an aspect of the invention, there is provided a system for treating a fine structure, including: a rinse-solution-supplying mechanism configured to supply a liquid that has a smaller surface tension than that of water and is not substantially compatible with water, to a surface of the fine structure having protrusions on the surface thereof, and a reclamation mechanism configured to collect and reclaim the liquid supplied to the surface.

According to an aspect of the invention, there is provided a method for producing an electronic device, wherein a surface is cleaned up by a treatment method, the method includes: supplying a liquid that has a smaller surface tension than that of water and is not substantially compatible with water, to a surface of the fine structure having protrusions on the surface thereof; and thereby treating the surface of the fine structure.

According to an aspect of the invention, there is provided a method for producing an electronic device, wherein a surface is cleaned up by using a treatment system, the method includes: a rinse-solution-supplying mechanism configured to supply a liquid that has a smaller surface tension than that of water and is not substantially compatible with water, to a surface of the fine structure having protrusions on the surface thereof, and a reclamation mechanism configured to collect and reclaim the liquid supplied to the surface.

### BRIEF DESCRIPTION OF THE DRAWINGS

FIG. 1 is a flow chart for illustrating a method for treating a fine structure according to a first embodiment of the invention;

FIGS. 2A to 2E are schematic sectional views for illustrating the effect of surface tension of a residual liquid (rinse liquid) between protrusions;

FIG. 3 is a flow chart illustrating a method for treating a fine structure according to a second embodiment of the invention;

FIG. 4 is a schematic view illustrating a system for treating a fine structure according to a third embodiment of the invention; and

FIG. 5 is a schematic view for illustrating a system for treating a fine structure according to a fourth embodiment of the invention.

### DETAILED DESCRIPTION OF THE INVENTION

Hereinafter, embodiments of this invention will be exemplified with reference to drawings.

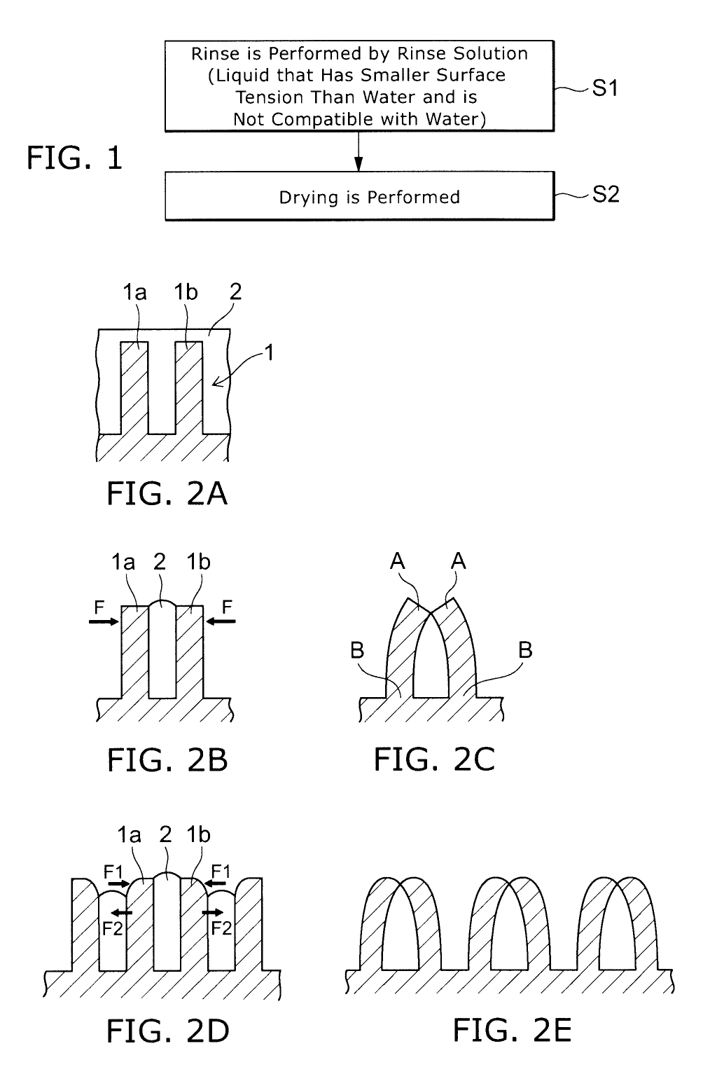

FIG. 1 is a flow chart for illustrating a method for treating a fine structure according to a first embodiment of the invention.

FIGS. 2A to 2E are schematic sectional views for illustrating the effect of surface tension of a residual liquid (rinse liquid) between protrusions.

First, the effect of surface tension of the residual liquid (rinse liquid) between protrusions will be explained.

As shown in FIG. 2A, in rinsing a fine structure 1 by using a rinse liquid 2, a surface of the fine structure 1 is covered with the rinse liquid 2, and the rinse liquid 2 is also satisfied between the protrusions 1a, 1b such as wall bodies formed on the surface (in a pattern). Here, each of the protrusions may have a wall shape, or may have a rod shape such as a columnar shape or a prismatic shape.

And, as shown in FIG. 2B, by drying performed in the rinse, the rinse liquid 2 is removed from the surface of the fine structure 1, and the upper surfaces of the protrusions 1a, 1b are exposed to the air, and therefore, the acting forces F pushing the protrusions 1a, 1b from the sides thereof come to function by the surface tension of the rinse liquid 2 staying between the protrusions 1a, 1b.

In this case, if strength of the protrusions 1a, 1b is sufficiently high, the effect of the acting forces F is small, but according to quality of material, degree of miniaturization (integration degree), aspect ratio, or the like of the fine structure 1, it become necessary to suppress generation of the acting forces F. For example, in the fields of the electronic device such as semiconductor device or MEMS, when the design rule is 30 nm (nanometer) or less, the effect of the action forces F cannot be ignored.

In such a case, in FIG. 2C, there is a danger that the protrusions 1a, 1b are deformed so as to be curved. And, when the deformation of the protrusions 1a, 1b is caused, there are dangers that contact is caused in the apical ends and that break or crack is caused in the bases B.

Moreover, when the shapes of the protrusions 1a, 1b are not symmetric, the acting forces F become nonuniform and the deformation of the protrusions 1a, 1b becomes easily caused. For example, in the case shown in FIG. 2D, the amounts of the residual rinse liquid 2 between the protrusions 1a, 1b are different, magnitudes and action positions of acting forces F1, F2 generated by the surface tension become different. That is, as shown in FIG. 2D, the acting force F1 is larger than the action force F2, and also, the action position of the acting force F1 is in the more distal side. Therefore, because the bending moment generated by the acting force F1 becomes large, such deformation of the direction as shown in FIG. 2E becomes easily caused.

The fine structure 1 illustrated in FIG. 2 is a structure made of simple material (such as silicon amorphous silicon), but this is the same, for example, in the case that the fine structure 1 is made of metal, silicon, oxide, or the like.

For finding the effect by the surface tension, a wafer which a pattern by the 30-nm (nanometer) design rule is formed on a surface of was spin-rinsed by pure water (frequency; about 500 rpm, rinse time; about 60 seconds), and spin-dried (frequency; about 2500 rpm, rinse time; about 60 seconds), and the patterns before the rinse and after the rinse were comparatively inspected by a pattern inspection apparatus manufactured by KLA inc. As a result, 12 places of deformation were confirmed in the pattern after the rinse.

In this case, when the rinse liquid having a smaller surface tension than that of water is used, the deformation or destruction of the protrusion can be suppressed.

The rinse liquid having a smaller surface tension than that of water includes isopropyl alcohol. Here, if isopropyl alcohol is supplied when water exists on a surface of the fine structure, Marangoni force is generated. “Marangoni force” is a force generated by attraction of the liquid having a small surface tension (isopropyl alcohol) to the liquid having a large surface tension (water). When Marangoni force is generated, there is a danger that deformation, destruction, or the like of the protrusions is generated in the same manner as the above-described case of the surface tension. In this case, even if ultrapure water or the like is not positively supplied to the surface of the fine structure, in the case of the isopropyl alcohol, which is compatible with water, there is a danger that Marangoni force is generated by taking in moisture in the air. That is, a substance compatible with water is not preferable even if the substance is a liquid having a smaller surface tension than that of water because the substance can generate Marangoni force.

Moreover, because there is a danger that the substance compatible with water takes in moisture in the air even if the substance is not set to be an aqueous solution, there is also a danger that a water mark is formed after drying. And, also in the case of achieving recycle (in the case of performing recycle) of the rinse liquid to be described later, it becomes difficult to separate the substance from water and therefore the production system gets complex and high cost is caused.

As a result of studies, the present inventors have obtained knowledge that when a liquid that has a smaller surface tension than that of water and that is not substantially compatible with water is used as the rinse liquid, the effect of surface tension and the generation of Marangoni force can be suppressed. In this case, because taking in of moisture from the air can also be suppressed, formation of water mark can be suppressed. Moreover, even if taking in of moisture from the air exists, the water can be relatively easily separated and therefore the recycle becomes easy.

The liquid that has a smaller surface tension than that of water and that is not substantially compatible with water can includes, for example, fluorinated liquid such as hydrofluorocarbon and hydrofluoroether and perfluorocarbon and hydrochlorofluorocarbon, linear hydrocarbon and derivatives thereof such as pentane and hexane (CH₃CH₂CH₂CH₂CH₂CH₃), aromatic hydrocarbon and derivatives thereof such as benzene (C₆H₆) and toluene (C₆H₅CH₃), ether having small polarity such as diethyl ether and tetrahydrofuran (THF), halogenated solvent such as chloroform (CHCl₃) and methylene chloride (CH₂Cl₂), and ester having small polarity such as ethyl acetate (CH₃C(═O)OCH₂CH₃).

In this case, for using the liquid as the rinse liquid, it is necessary to consider rinse capability, reusability (reduction of environmental load), chemical stability, safety, and so forth. And, high rinse capability and high reusability are important for reducing environmental load. Here, in the case of considering reusability, it is necessary to consider that separation or removal of the solving metal impurities (metal ions) is easy and that the separation of the liquid from water is easy and that vapor of the liquid is heavy and therefore the collection thereof is easy.

By considering the above-described things, it is preferable to use the fluorinated liquid as the rinse liquid. Here, the specific example of the fluorinated liquid includes, Vertrel (registered trademark) manufactured by DU PONT-MITSUI FLUOROCHEMICALS COMPANY, LTD. as hydrofluorocarbon, Novec (trade name) manufactured by 3M inc. as hydrofluoroether, Fluorinert (trade name) manufactured by 3M inc. as perfluorocarbon, Asahiklin (registered trademark) manufactured by Asahi glass Co., Ltd. as hydrochlorofluorocarbon. However, the fluorinated liquid is not limited thereto and can be appropriately modified. Moreover, they can be used with being appropriately mixed, and it is sufficient that at least one kind or more thereof is used.

Next, a method for treating a surface of the fine structure according to the first embodiment of this invention will be explained with returning to FIG. 1. Specifically, in this embodiment, a method of cleansing a surface of the fine structure to clean up the surface will be explained.

For the convenience of explanation, a wafer in which a pattern of the fine structure 1 by a 30-nm (nanometer) design rule is formed on a surface thereof will be explained.

First, a liquid that has a smaller surface tension than that of water and that is not compatible with water (hereinafter, simply referred to as rinse solution) is supplied to a wafer surface on which the pattern is formed (the fine structure surface on which the protrusions are formed) and thereby the rinse is performed (Step S1).

Here, from the wafer surface on which the pattern is formed (the fine structure surface on which the protrusions are formed), impurities such as metal ions can be removed.

For the rinse, a spin cleaning method can be used. In this case, frequency can be about 500 rpm, and the rinse time can be about 60 seconds. The rinse method is not limited to the spin cleaning method, but another wet cleaning method such as immersion cleaning method can be appropriately selected. Moreover, by applying ultrasonic vibration to the rinse solution, the rinse force can be enhanced. In this case, the frequency of the ultrasonic wave can be about 700 kHz to 3 MHz.

Moreover, only the rinse solution can be discharged and a binary fluid of a gas and the rinse solution can be mixed and discharged or sprayed.

The rinse solution can include, for example, the above-described fluorinated liquid (such as hydrofluorocarbon, hydrofluoroether, perfluorocarbon, and hydrochlorofluorocarbon).

When the fluorinated liquid is used, removal of contaminant by dissolution and removal of the dissolved contaminant by separation can be easily performed because the liquid has moderate rinse capability and is also chemically stable. Moreover, the liquid has high security because of noncombustibility, and facilities having explosion-proof specifications in such a case as using isopropyl alcohol are not required. Moreover, because the liquid has high specific gravity, the striking power in the rinse can be enhanced and the rinse capability can be improved.

Moreover, formation of water mark can also be suppressed.

Here, it is thought that a factor that the water mark is formed is as follows. That is, when the water exists in the wafer surface, water, oxygen in the air, and silicon in the wafer surface react as the following formula (I) to generate H₂SiO₃.

Si+H₂O+O₂→H₂SiO₃ (1)

And, when drying progresses, the reaction product (H₂SiO₃) is precipitated to form the water mark.

In the present example, water is not contained in the rinse solution. Moreover, if the water is taken in, the water can be comparatively easily removed. Therefore, the reaction of the above-described formula (1) can be inhibited, and therefore, formation of the water mark can be suppressed.

Next, drying of the wafer surface (one example of the fine structure surface on which the protrusions are formed) is performed (Step S2).

In this case, with rotating the wafer, drying (spin-drying) can be performed. For example, drying can be performed with performing the rotation so that the frequency is about 2500 rpm.

Also, drying can be performed by performing heating with rotating the wafer. In this case, for example, the heating temperature can be set to be about 150° C., and the heating temperature can be set to be about 60 seconds, and the frequency can be set to be about 500 rpm.

Also, by supplying vapor of the rinse solution to the wafer surface, drying can be performed. That is, drying can be set to be performed by using vapor of the rinse solution. In this case, as the vapor of the rinse solution, as well as the vapor obtained by heating the rinse solution, a mixed gas or the like by diluting the vapor of the rinse solution with a nitrogen gas or the like can be used. As the vapor, superheated vapor can also be used.

Moreover, the drying methods can be appropriately combined.

Here, when the surface tensions of the other liquids and the fluorinated liquid are compared, the surface tension of water is 73 mN/m, the surface tension of isopropyl alcohol is 21 mN/m, and by contrast, the surface tension of the fluorinated liquid is 14 mN/m, which is low. Therefore, deformation or destruction or the like of the protrusions due to the above-described surface tension can be drastically suppressed.

Moreover, because the fluorinated liquid is a liquid that is not compatible with water, generation of Marangoni force can be suppressed. Moreover, the evaporation heat is low (about 120 kj/kg) and immediate drying can also be performed. Moreover, because the vapor thereof is heavy and the collection thereof is easy, recycle thereof can be easily performed.

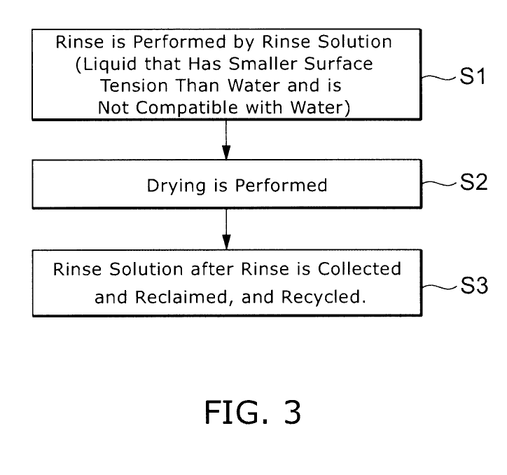

FIG. 3 is a flow chart illustrating a method for treating the fine structure according to a second embodiment of this invention.

For the convenience of explanation, a wafer in which a pattern of the fine structure 1 by a 30-nm (nanometer) design rule is formed on a surface thereof will be explained. Moreover, the same signs are appended to the same steps as illustrated in FIG. 1, and the explanation thereof will be omitted.

First, a liquid that has a smaller surface tension than water and that is not compatible with water (rinse solution) is supplied to a wafer surface on which the pattern is formed (the fine structure surface on which the protrusions are formed) and thereby the rinse is performed (Step S1).

Next, drying of the wafer surface (the fine structure surface on which the protrusions are formed) is performed (Step S2).

Next, the rinse liquid after the rinse is collected and reclaimed, and recycled (Step 3).

That is, the rinse solution supplied to the wafer surface (the fine structure surface on which the protrusions are formed) is collected and reclaimed, and thereby, the rinse solution is recycled.

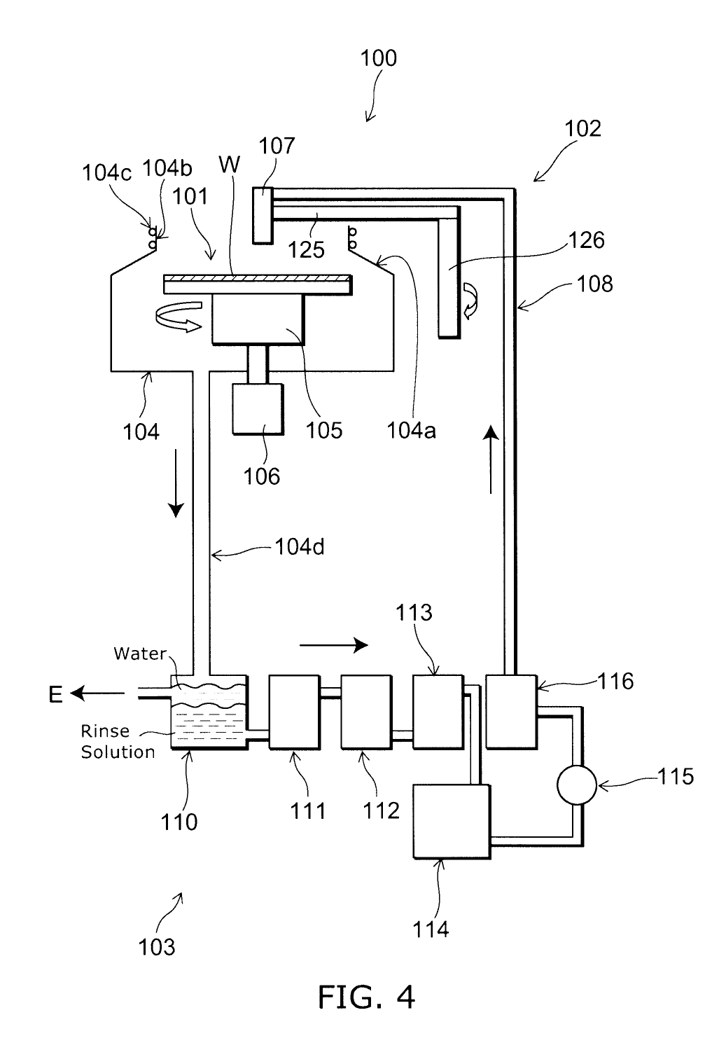

The collection of the rinse solution can be performed through a discharge duct 104d like a treatment system 100 (see FIG. 4) to be described later. The collection may be performed by utilizing specific gravity, or may be performed by a liquid-sending mechanism such as pump.

The reclamation can be performed through; for example, separation and removal of water, separation and removal of solid bodies, and separation and removal of the dissolved impurities (for example, metal ions).

As the separation and removal of water, it can be exemplified that only the water is removed by separating the water and the rinse solution by utilizing the difference of specific gravity. For example, in the above-described case of the fluorinated liquid, because the specific gravity is about 1.4, which is heavy, the water and the rinse solution can be relatively easily separated.

Also, by separating the water and the rinse solution by utilizing the difference of the boiling points, only the water can be removed. For example, in the above-described case of the fluorinated liquid, the boiling point is about 60° C., which is low, and therefore, the water and the rinse solution can be relatively easily separated by using a distiller.

Also, the water and the rinse solution can be separated by using a drying agent or the like.

In this case, if the water and the rinse solution are separated by using a distiller or a drying agent or the like, a larger amount of water can be removed. Moreover, the separation and removal methods can be combined. For example, after separating the water and the rinse solution by utilizing the difference of specific gravities, the water and the rinse solution can be further separated by using a distiller or a drying agent or the like being capable or removing a larger amount of water.

The separation and removal of solid bodies can be performed by using various filters.

The separation and removal of dissolved impurities can be performed by, for example, using a filter having ion-exchange resin. The same ion-exchange resin as used for production of pure water or ultrapure water can be used. For example, strongly acidic cation exchange resin, slightly acidic cation exchange resin, strongly basic anion exchange resin, slightly basic anion exchange resin, or the like can be exemplified. Also, cation exchange resin and anion exchange resin can be combined and used.

Moreover, in the case of removing metal ions as the dissolved impurities, fiber equipment to which a functional group being capable of capturing metal ions is fixed can be used. Such a functional group includes a functional group having a capability of forming metal chelate, and for example, includes a sulfonic group.

As the material of the fiber equipment, a raw material that can be made to be fiber and that a functional group having capability of forming metal chelate can be introduced to can be used singly or a mixed material thereof can be used. For example, fluorine resin, polyester, polyvinyl chloride, polyacrylonitrile, or polyamide can be used. In this case, in the case of using the fluorinated liquid as the rinse solution, there is a danger that the fluorinated resin swells, and therefore, it is preferable to use the material not containing fluorinated resin.

In the case of using the fluorinated liquid, it is preferable that in the parts directly contacting the rinse solution such as a pipe or housing as well as the filter, materials not containing fluorinated resin are used.

In such a case as a pattern by a design rule of 30 nm (nanometers) or less, it is preferable to perform the separation and removal of the dissolved impurities to PPT (Parts Per Trillion) level. In this case, the separation and removal can be performed in a stepwise manner. For example, in the filter of the first stage, the separation and removal of PPM (Parts Per Million) level to PPB (Parts Per Billion) level can be performed, and by the subsequent filter(s), the separation and removal of PPB (Parts Per Billion) level to PPT (Parts Per Trillion) level can be performed.

As the recycle, the reclaimed rinse solution is supplied to the wafer surface (the fine structure surface on which the protrusions are formed) by using a liquid-sending mechanism such as a pump like the treatment system 100 to be described later, and thereby, the collection, the reclamation, the supply can be performed so as to be circulated.

Here, in the case of using the fluorinated liquid as the rinse solution, even if moisture in the air is taken in, the water can be relatively easily separated and therefore, the rinse solution can be easily reclaimed. Moreover, the liquid is chemically stable and therefore the dissolved contaminant can be easily separated and removed. Moreover, because vapor of the liquid is heavy and the collection thereof is easy, the recycle efficiency can be improved.

Next, a system for treating a fine structure according to the embodiments of the invention will be exemplified. FIG. 4 is a schematic view illustrating the system for treating a fine structure according to a third embodiment of the invention. Arrows in the figure represent the flow directions of the liquid (rinse solution or the separated water).

Here, for convenience of explanation, a wafer W having the fine structure 1 will be explained.

As shown in FIG. 4, the system 100 for treating a fine structure includes a holding mechanism 101 holding the wafer W (having the fine structure 1), a rinse-solution-supplying mechanism 102 for supplying a rinse solution to a surface of the wafer W on which a pattern is formed, a reclamation mechanism 103 for collecting and reclaiming the rinse solution (rinse solution after the rinse) supplied to the surface of the wafer W. Moreover, the holding mechanism 101 is provided inside a chamber 104.

In the holding mechanism 101, a chuck 105 being capable of holding the wafer W and a driving mechanism 106 (such as a motor) for rotating the chuck 105 are provided. The chuck 105 holds one wafer W horizontally and can be rotated at a speed of several hundred to several thousand revolutions per minute by the driving mechanism 106. Therefore, the wafer W held on the chuck 105 can also be rotated with the chuck 105.

The rinse-solution-supplying mechanism 102 has a nozzle 107 provided above the chuck 105 for supplying the rinse solution toward the surface of the wafer W. The nozzle 107 may discharge only the rinse solution or may mix and discharge or splay a binary fluid of a gas and the rinse solution. Moreover, the nozzle 107 can be provided with an ultrasonic-wave-oscillating mechanism, which is not shown, so that ultrasonic vibration is added to the rinse solution to be discharged. Moreover, the nozzle 107 is held by an arm 125, and the arm 125 is set to be rotatable so that the rotational axis 126 serves as the rotation center.

The reclamation mechanism 103 includes a first removal mechanism 110 for separating and removing water, a second removal mechanism 111 for separating and removing sold bodies, a third removal mechanism 112 for separating and removing dissolved impurities (such as metal ions), a fourth removal mechanism 113 for further separating and removing dissolved impurities (such as metal ions), a tank 114 for storing the rinse solution from which the dissolved impurities (such as metal ions) are removed, a liquid-sending mechanism 115 for sending the stored rinse solution to the nozzle 107, and a fifth removal mechanism 116 for separating and removing fine solid bodies such as particles.

The first removal mechanism 110 separates the water and the rinse solution by utilizing the difference of the specific gravities and can remove only the water. In the case illustrated in FIG. 4, the rinse solution having large specific gravity (such as fluorinated liquid) accumulates in the lower part, and the water having small specific gravity in the upper part thereof. Therefore, the water accumulating in the upper part is exhausted and thereby the separation and removal of the water can be performed.

As the second removal mechanism 111, various filters being capable of separation and removal of the solid bodies can be used. As the third removal mechanism 112 and the fourth removal mechanism 113, the filter being capable of performed separation and removal of dissolved impurities (such as a filter having ion exchange resin) can be used. In this case, the third removal mechanism 112 can be set to perform the separation and removal of PPM (Parts Per Million) level to PPB (Parts Per Billion) level. Moreover, the fourth removal mechanism 113 can be set to perform the separation and removal of PPB (Parts Per Billion) level to PPT (Parts Per Trillion) level. In this case of removing metal ions, such fiber equipment to which a functional group being capable of capturing metal ions is fixed. As the fifth removal mechanism 116, various filters being capable of separating and removing fine solid bodies such as particles can be used.

The tank 114 is not particularly limited as long as being capable of storing the rinse solution from which dissolved impurities are removed. Moreover, the tank 114 is not necessarily required and can be omitted. However, if the tank 114 is provided, supply of the rinse solution can be stabilized.

The liquid-sending mechanism 115 can be a pump and is not particularly limited as long as being capable of sending the stored rinse solution.

The chamber 104 can receive the rinse solution spattering by rotation of the wafer W and exhaust the rinse solution. In the upper part of the chamber 104, a slope 104a for receiving the spattering rinse solution and guiding the rinse solution into the chamber 104 is provided. Moreover, outside an opening 104b provided further above the slope 104a, a cooling mechanism 104c is provided. Moreover, in the bottom of the chamber 104, an exhaust duct 104d for exhausting the rinse solution introduced into the chamber 104 to the outside and collecting the rinse solution is connected.

As the cooling mechanism 104c, for example, a metal pipe inside which a coolant circulates, or the like can be used. The cooling mechanism 104c is provided for cooling to devolatilize the vapor of the rinse solution and collecting the rinse solution.

The exhaust duct 104d is connected to the first removal mechanism 110 of the reclamation mechanism 103, and the fifth removal mechanism 116 of the reclamation mechanism 103 and the nozzle 107 of the rinse-solution-supplying mechanism 102 are connected through a pipe 108. Therefore, the rinse solution after the rinse can be collected, reclaimed, and supplied, and can be circularly recycled. The collection may be performed by utilizing gravitation or by using a liquid-sending mechanism such as pump. Moreover, control valves, which are not shown, are appropriately provided in each of parts of the pipes, and thereby, sending and stopping of the rinse solution can be controlled.

In the case of using a fluorinated liquid as the rinse solution, in parts directly contacting the rinse solution such as the filter, the pipes, and the chamber, materials not containing fluorinated resin are used for suppressing swelling.

Next, the action of the system 100 for treating a fine structure will be exemplified.

The wafer W is carried in the chamber 104 by a conveying mechanism, which is not shown, and put on the chuck 105 and held. And, by driving mechanism 106, the chuck 105 is rotated and thereby the wafer W rotates.

Next, the rinse solution is supplied from the nozzle 107 disposed above the wafer W to the surface of the wafer W. After supplying a predetermined amount of the rinse solution required for the rinse to the surface of the wafer W, the supply of the rinse solution is stopped.

Next, the rotation of the chuck 105 is stopped, and the wafer W is carried out by a conveying mechanism, which is not shown. The wafer W carried out is dried by a drying mechanism, which is not shown, and thereby, cleaning up of the wafer W is performed. By rotating the wafer W to remove the residual rinse solution, the wafer W can also be dried (spin-dried).

Then, according to need, the above-described procedure is repeated, and thereby, cleaning up of the subsequent wafer W can be performed.

On the other hand, the rinse solution after the rinse is set to the reclamation mechanism and reclaimed by performing separation and removal of water, separation and removal of solid bodies, and separation and removal of dissolved impurities (such as metal ions). And, the reclaimed rinse solution is stored in the tank 114, and sent to the nozzle 107 with performing separation and removal of fine solid bodies such as particles. And, the recycle is achieved by supplying the rinse solution to the surface of the wafer W from the nozzle 107. As described above, the rinse solution after the rinse is collected, reclaimed, supplied, and circularly recycled by repeating the above-described procedure.

In the present embodiment, the rinse is performed in the system 100 for treating a fine structure, and drying is performed by the drying mechanism, which is not shown. When the functions are divided as described above, the number of the apparatuses charging processes each requiring a long treatment time is increased to reduce the waiting time, and thereby, the productivity can be improved.

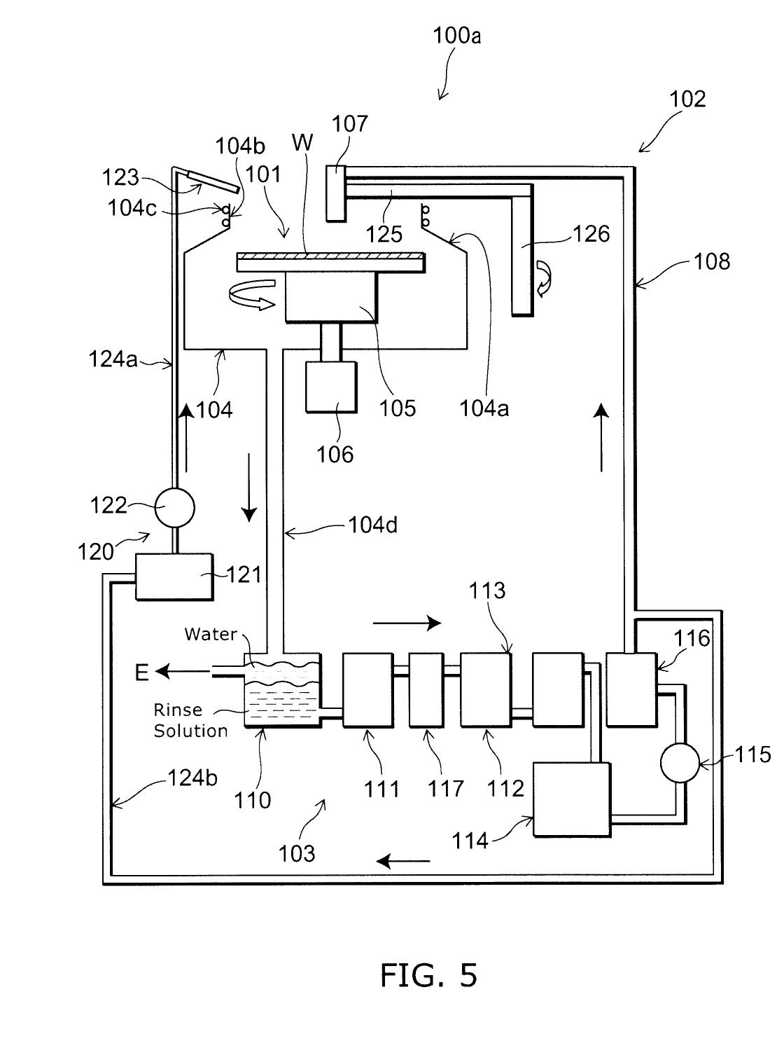

FIG. 5 is a schematic view for illustrating a system for treating a fine structure according to a fourth embodiment of this invention. The same signs are appended to the same components as illustrated in the FIG. 4, and the explanation thereof will be omitted. Moreover, the arrows represent the flow directions of the liquid (rinse solution or separated water).

The system 100a for treating a fine structure has a drying mechanism 120 for supplying vapor of the rinse solution to the surface of the wafer W to perform drying. In the drying mechanism 120, an evaporator 121 for generating saturated vapor, a superheater 122 for generating superheated vapor, and a nozzle 123 provided above the chuck 105 for spraying the superheated vapor toward the surface of the wafer W are provided.

The evaporator 121, the superheater 122, and the nozzle 123 are connected by a pipe 124a, and the evaporator 121 is connected to the exit side of the fifth removal mechanism 116 by a pipe 124b. Therefore, the rinse solution supplied from the fifth removal mechanism 116 can be heated and made to be saturated vapor. And, the saturated vapor can be superheated by the superheater 112 and made to be dry vapor (superheated vapor) without mist, and the superheated vapor can be spayed toward the wafer W from the nozzle 123. And, by the superheated vapor, the surface of the wafer W can be dried. Moreover, the sprayed superheated vapor is cooled and devolatilized by the cooling mechanism 104c and thereby collected.

The drying mechanism 120 for spraying superheated vapor exemplified, but this invention is not limited thereto. For example, it is also possible that a heating mechanism, which is not shown, is provided in the chamber 104 and vapor of the rinse solution is generated and the wafer W is exposed to the vapor and thereby dried. Moreover, it is also possible that the heated gas is sprayed toward the wafer or the wafer W is heated by a heating mechanism, which is not shown, provided in the chuck 105 or the like, and thereby drying is performed. However, when drying is performed by using vapor, the cleaning level can be more enhanced.

Moreover, the distiller 117 is provided between the second removal mechanism 111 and the third removal mechanism 112. And the distiller 117 separates the water and the rinse solution by utilizing the difference of boiling points and removes the water. It is also possible that by using a drying agent or the like, the water and the rinse solution can be separated. Moreover, the disposition position of the distiller 117 or the drying agent is not limited to the position shown in the figure, and disposition at an optional position in the downstream side of the first removal mechanism 110 is possible.

The distiller 117 or the drying agent is not necessarily required, but in the case of the pattern by a design rule of 30 nm (nanometers) or less, it is preferable that the distiller 117 or the drying agent is provided for removing larger amount of water.

Control valves, which are not shown, are appropriately provided in each of the pipes, and sending or stopping or the like of the rinse solution can be controlled. Moreover, in the case of using a fluorinated liquid as the rinse solution, in parts directly contacting the rinse solution such as the filter, the pipes, and the chamber, materials not containing fluorinated resin are used for suppressing swelling.

In this embodiment, only in the system 100a for treating a fine structure, cleaning up can be performed by rinsing and drying the wafer W. Therefore, space efficiency can be enhanced.

Next, action of the system 100a for treating a fine structure will be exemplified.

Rinse, collection and reclamation and recycle of the rinse solution, and so forth are the same as the system 100 for treating a fine structure illustrated in FIG. 4, and therefore, the explanation thereof will be omitted.

The wafer W rinsed by the rinse solution rotates with the chuck 105 by the driving mechanism 106.

Next, superheated vapor of the rinse solution is splayed to the surface of the rotating wafer W from the nozzle 123 provided above the wafer W. After a predetermined amount of superheated vapor required for drying is sprayed to the surface of the wafer W, the supply of the superheated vapor is stopped.

On the other hand, the rinse solution supplied from the fifth removal mechanism 116 is heated by the evaporator 121 to be saturated vapor. And, the saturated vapor is superheated by the superheater 122 and thereby made to be dry vapor (superheated vapor) without mist and sprayed from the nozzle 123.

Moreover, by distiller 117 or the like, larger amount of water contained in the rinse solution is removed.

For convenience of explanation, as the system for treating a fine structure, the single wafer processing system has been exemplified, but a batch processing system is also possible. For example, a plurality of fine structures may be rinsed and dried in a treatment tank at one time. Moreover, the spin cleaning system has been exemplified, but this invention is not limited thereto, but another wet cleaning system such as immersion cleaning system can be used.

Moreover, as the system for treating a fine structure, an apparatus for forming protrusions on a surface can be included. For example, the system for treating a fine structure can be composed by incorporating each of the apparatuses used in a so-called lithography processes such as, resist application, exposure, development, etching, and resist removal into the line, or the like. Known techniques can be applied to each of the apparatuses used in the lithography processes, and therefore, the explanation thereof will be omitted.

Moreover, for convenience of explanation, the fine structure has been explained by a wafer, but this invention is not limited thereto. For example, this invention can also be applied to liquid-crystal display apparatus, phase-shift mask, micromachine in the MEMS field, precision optics, and so forth.

Next, a method for producing an electronic device according to the embodiment of the invention will be exemplified.

As the method for producing an electronic device, a method for producing a semiconductor device can be exemplified. The method for producing a semiconductor device is carried out by repeating a plurality of processes such as, forming a pattern (protrusions) on a wafer surface by film formation and resist application and exposure and development and etching and resist removal and so forth, inspection, heat treatment, impurity introduction , diffusion, and planarization.

And, in the method for producing a semiconductor device, rinse is performed in various steps such as, initial rinse performed in taking the wafer in a clean room, rinse performed before and after oxidation treatment, rinse performed before and after film formation treatment, rinse after etching or resist removal, and rinse after planarization. Therefore, in the rinse, the above-described method for treating a fine structure and the above-described system for treating a fine structure according to this embodiment can be used.

In this case, when the treatment method or the treatment system is used after a pattern (protrusions) is formed, deformation, damage, or the like of the protrusions can be suppressed, and therefore, yield can be improved. In particular, suppression effect of the deformation or damage for the fine structure having a design rule of 30 nm (nanometers) or less is large, and yield can be drastically improved.

For convenience of explanation, the method for producing a semiconductor device has been exemplified as the method for producing an electronic device according to the embodiment of the invention, but the invention is not limited thereto. For example, a pattern (protrusions) in the production of liquid-crystal display apparatus also becomes finer in recent years, and there is a danger that deformation or damage or the like of the protrusions in rinse or in drying is generated. As described above, for another electronic device becoming finer in recent years, the method for treating a fine structure and the system for treating a fine structure according to this embodiment can be used, and by suppressing deformation or damage or the like of the protrusions, yield can be improved.

As described above, the embodiments of the invention has been exemplified. However, the invention is not limited to these descriptions.

The above-described embodiments design-modified by those skilled in the art are also included in the scope of the invention as long as having characteristics of the invention.

For example, shape, size, material, disposition, number, or the like of each of the components that the fine structure or the system for treating a fine structure has is not limited to the exemplified ones, but can be appropriately modified.

Moreover, each of components that each of the above-described embodiments has can be combined if at all possible, and combination thereof is also included in the scope of the invention as long as including the characteristics of the invention.

1. A method for treating a fine structure, comprising:
supplying a liquid that has a smaller surface tension than that of water and is not substantially compatible with water, to a surface of the fine structure having protrusions on the surface thereof; and thereby
treating the surface of the fine structure.

2. The method according to claim 1, wherein the liquid supplied to the surface is collected and reclaimed.

3. The method according to claim 1, wherein in the treatment, drying of the surface of the fine structure is performed by using vapor of the liquid.

4. The method according to claim 1, wherein in the treatment, drying of the surface of the fine structure is performed by using superheated vapor of the liquid.

5. The method according to claim 2, wherein the reclamation includes removing water from the collected liquid, removing solid from the liquid from which the water is removed, and removing dissolved impurities from the liquid from which the water and the solid is removed.

6. The method according to claim 5, wherein the dissolved impurities are metal ions.

7. The method according to claim 5, wherein the removal of the dissolved impurities is performed to PPT (Parts Per Trillion) level.

8. The method according to claim 5, wherein the removal of the dissolved impurities is performed by using ion-exchange resin.

9. The method according to claim 1, wherein the liquid is a fluorinated liquid.

10. The method according to claim 1, wherein the liquid is at least one or more kinds selected from a group consisting of hydrofluorocarbon, hydrofluoroether, perfluorocarbon, and hydrochlorofluorocarbon.

11. A system for treating a fine structure, comprising:
a rinse-solution-supplying mechanism configured to supply a liquid that has a smaller surface tension than that of water and is not substantially compatible with water, to a surface of the fine structure having protrusions on the surface thereof, and
a reclamation mechanism configured to collect and reclaim the liquid supplied to the surface.

12. The system according to claim 11, further comprising a drying mechanism configured to dry the surface of the fine structure.

13. The system according to claim 12, wherein in the drying mechanism, a superheater configured to generate superheated vapor is provided.

14. The system according to claim 11, wherein in the rinse-solution-supplying mechanism, an ultrasonic-wave-oscillating mechanism configured to add ultrasonic vibration to the liquid is provided.

15. The system according to claim 11, wherein a part of the system directly contacting the liquid does not include fluorinated resin.

16. The system according to claim 11, wherein the reclamation mechanism removes metal ions contained in the collected liquid.

17. The system according to claim 11, wherein in the reclamation mechanism, fiber equipment to which a functional group being capable of capturing metal ions is fixed is provided.

18. The system according to claim 11, further comprising a cooling mechanism configured to devolatilize and collect the vapor of the liquid.

19. A method for producing an electronic device, wherein a surface is cleaned up by a treatment method, including:
supplying a liquid that has a smaller surface tension than that of water and is not substantially compatible with water, to a surface of the fine structure having protrusions on the surface thereof; and thereby
treating the surface of the fine structure.

20. A method for producing an electronic device, wherein a surface is cleaned up by using a treatment system, including:
a rinse-solution-supplying mechanism configured to supply a liquid that has a smaller surface tension than that of water and is not substantially compatible with water, to a surface of the fine structure having protrusions on the surface thereof, and
a reclamation mechanism configured to collect and reclaim the liquid supplied to the surface.
